(19) United States
(12) Patent Application Publication
(10) Pub. No.: US 2002/0137831 A1
(43) Pub. Date: Sep. 26, 2002

(54) Polymeric PTC composition and circuit protection device made therefrom

(76) Inventors: Hideo Horibe, Tokyo (JP); Itsuo Nishiyama, Tokyo (JP); Osamu Hiroi, Tokyo (JP); Teijiro Mori, Tokyo (JP); Tatsuya Hayashi, Tokyo (JP); Chie Takahashi, Tokyo (JP); Shiro Murata, Tokyo (JP); Kenichi Nishina, Tokyo (JP); Manabu Sogabe, Tokyo (JP); Masahiro Ishikawa, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/553,158

(22) Filed: Apr. 20, 2000

Related U.S. Application Data
(63) Continuation-in-part of application No. 09/172,003, filed on Oct. 14, 1998, now abandoned.

(30) Foreign Application Priority Data
Jan. 22, 1998 (JP) 10-10513
Feb. 28, 1997 (JP) 9-45681

(51) Int. Cl. C08K 3/08

(52) U.S. Cl. 524/439

(57) ABSTRACT

Disclosed is a polymeric PTC composition comprising an organic polymer and conductive particles having a melting point of not less than 2000° C. dispersed therein and a circuit protection device comprising a PTC element comprising the PTC composition which are treated with a coupling agent and at least two electrodes which are electrically connected to the PTC element. The polymeric PTC composition is used to provide a circuit protection device having excellent environmental resistance properties, which exhibits a low resistance under normal operating conditions, and protects the circuit against the over-current even under large electric current and high voltage.

### BACKGROUND OF THE INVENTION

1. Field of the Invention

The present invention relates to an electrical material, in particular it relates to a material composition having a positive temperature coefficient (PTC) of resistivity, which undergoes a rapid and sharp increase in resistance over a relatively narrow temperature range as temperature increases, i.e., a polymeric PTC composition, and to a circuit protection device employing the same, which is used for a breaker and the like.

2. Description of the Related Art

A PTC composition having the above-mentioned PTC characteristics has been generally used for a circuit protection element and the like which limits the current-flow in a circuit including a heater, a positive characteristic thermistor, a heat sensor, a battery and the like, under short-circuit condition, and resets the circuit when the cause of the short-circuit is removed.

Further applications of the PTC composition include a circuit protection device incorporated in a circuit which comprises a PTC element made of the PTC composition and at least two electrodes electrically connected thereto, for use in protecting against over-voltage or over-temperature by the temperature self controlling function of the PTC element.

Now, the protection mechanism obtained with the PTC element against over-current will be described. As the resistivity (ρ_{L}) of a PTC composition at an ordinary room temperature is sufficiently low, normally current flows through the circuit. But, if large current flows through the circuit by short-circuit accident and the like, Joule heat is generated in the PTC element due to the large current, and the temperature of the element rises, thus the resistivity increases (exhibition of PTC behavior), so that the current does not flow through the element and the circuit can be protected (this is referred to as current limiting performance).

The PTC element, i.e., the PTC composition needs to have such current limiting performance that can be exhibited repeatedly even under high voltage. Also a sufficiently lowered initial resistivity (ρ_{L}) and an effective PTC characteristic (a large ρ_{H}/ρ_{L}) will improve the current limiting performance of the PTC element. ρ_{H} refers to the peak resistivity which is given by a PTC curve at a high temperature.

Various materials have been developed as the PTC composition, and one of the conventionally known compositions comprises BaTiO₃ and an oxide of a monovalent or trivalent metal added thereto. This material, however, has a problem in that it exhibits NTC (Negative Temperature Coefficient) characteristics immediately after the PTC characteristics are exhibited, thus the current starts to flow again within 1 msec or less.

To cope with this problem, PTC compositions have been developed which comprise an organic polymer such as polyethylene (abbreviated as PE), polypropylene, and ethylene-acrylic acid copolymer, and conductive particles such as carbon black (abbreviated as CB), carbon fiber, graphite or finely divided metal particles, are dispersed therein. These PTC compositions are generally produced by adding, followed by kneading, conductive particles of a necessary amount to one or more kinds of resins which are used as the organic polymer.

If CB, carbon fiber or graphite is used as conductive particles, ρ_{L} of the resulting PTC element cannot be lowered to 0.1 Ωcm or less, even when the organic polymer is loaded with these conductive particles by closest packing, and when the ρ_{L} of the PTC element is decreased to the minimum value as low as 0.1 Ωcm, ρ_{H}/ρ_{L} is decreased as well to around 100 or so. Accordingly, the current limiting performance cannot be improved sufficiently.

On the other hand, the resistivity of metal particles per se is of the order of 10⁻⁶ Ωcm, and it is much lower than 0.05 Ωcm, the resistivity of CB per se. Accordingly, the ρ_{L} of the resulting PTC device is expected to be lowered by the use of metal particles such as Cu and Ni, and yet those metal particles have not been used as often as CB as the conductive particles for PTC compositions in the past. One of the biggest reasons for that is that the PTC compositions containing the conventionally known metal particles, used under large current and high voltage, cause an internal arc phenomenon (micro arc is generated between conductive particles) and the composition undergoes electrical breakdown. When the internal arc phenomenon is caused, the metal particles in the PTC composition become molten and the molten metal particles are bonded together to locally form a conductive circuit and the large current is concentrated in a part of the element and the element is destroyed. Discharge is also easily caused in a micro space between the composition and the electrode interface, the resin on the discharged part is degraded, and decomposed, thus the deterioration is accelerated disadvantageously. This inconvenience has been remarkable under an electric voltage of some 10 volts or higher. Accordingly, this type of composition has not been used for a self-reset type over-current protection element.

Although Japanese Patent Laid-Open No. 64-53503 discloses a PTC composition containing CB and metal particles as conductive particles, the metal particles are present in order to improve the heat-conductivity of the PTC composition.

Furthermore, Japanese Patent Laid-Open No. 5-508055, i.e., WO91/19297, relates to a method for producing a electronic device and discloses a composition comprising polymeric material and conductive particles dispersed therein. Although most Examples of the publication use nickel as the conductive particles of the PTC element, the conventional PTC element cannot sufficiently protect the circuit from over-current.

As described above, the metal particles have a very low resistivity compared to that of CB, thus when metal particles are used as conductive particles in the PTC composition, the resistivity (ρ_{L}) of the PTC element at an ordinary room temperature is decreased, and the PTC element is naturally expected to show good conductivity, but the conventionally known PTC composition containing metal particles causes internal arc phenomenon when used under large current and high voltage, and the metal particles are melted and a conductive circuit is locally formed, resulting in the destruction of the composition as well the PTC element. Therefore, the conventionally known PTC composition containing metal particles has a drawback in that it lacks safety and reliability and cannot protect the circuit repeatedly against an over-current.

### SUMMARY OF THE INVENTION

The present invention has been achieved in order to solve the above-mentioned problems, and an object of the present invention is to provide a PTC composition having a low resistance and good conductivity under normal operating conditions, which does not locally form a conductive circuit under large current and high voltage but exhibits PTC characteristics to increase the resistivity of the PTC element, and protects the circuit against over-current. That means, an object of the present invention is to provide a PTC composition having excellent current limiting performance, high safety, and high reliability and which can be used favorably, for example, for a self-reset type over-current protection element.

Another object of the present invention is to provide a circuit protection device of high safety and high reliability which has good conductivity under normal operating conditions, which shows excellent current limiting performance even under large current and high voltage and which works with high repeat stability.

Note that the present invention is not be directed to thermistors.

### SUMMARY OF THE INVENTION

The present invetion provides a polymeric positive temperature coefficient (PTC) composition comprising an organic polymer and conductive particles having a melting point of not less than 2000° C. dispersed in the organic polymer and selected from the group consisting of W and WC,

wherein an average particle size of said conductive particles is 0.01-10 μm,

wherein said conductive particles are contained in an amount of 50-99% by weight based on said composition,

wherein said conductive particles are treated with a coupling agent,

wherein said organic polymer is high density polyethylene having a melting point of from 120° C. to less than 140° C. and having a crystallinity of 60% or more, and

wherein said organic polymer is polyethylene having a melting point of from 120° C. to less than 140° C.,

wherein said composition is used under the condition that a ratio of over-current to an area of a PTC element consisting of said composition is at least 50 kA to 24 cm². Further, the present invention provides the polymeric PTC composition, wherein the metal is tungsten.

Furthermore, the present invention provides the polymeric PTC composition, wherein the coupling agent is an aluminum or a titanate coupling agent.

Still futher, the present invention provides the polymeric PTC composition according to claim 1, wherein the coupling agent is present in an amount of 0.05-10% by weight of the conductive particles.

Yet further, the present invention provides a circuit protection device comprising a positive temperature coefficient (PTC) element and at least two electrodes which are electrically connected to the PTC element,

wherein said positive temperature coefficient (PTC) element consists of a positive temperature coefficient (PTC) composition comprising an organic polymer and conductive particles having a melting point of not less than 2000° C. dispersed in the organic polymer and selected from the group consisting of W and WC,

wherein an average particle size of said conductive particles is 0.01-10 μm,

wherein said conductive particles are contained in an amount of 50-99% by weight based on said composition,

wherein said conductive particles are treated with a coupling agent,

wherein said organic polymer is high density polyethylene having a melting point of from 120° C. to less than 140° C. and having a crystallinity of 60% or more, and

wherein said organic polymer is polyethylene having a melting point of from 120° C. to less than 140° C.,

wherein said composition is used under the condition that a ratio of over-current to an area of a PTC element consisting of said composition is at least 50 kA to 24 cm².

### BRIEF DESCRIPTION OF THE DRAWINGS

FIG. 1 is a characteristic diagram showing the relationship between the particle size of the conductive particles (tungsten) according to the present invention and the resistivity of the PTC element at room temperature;

FIG. 2 is a characteristic diagram showing the relationship between the amount of the conductive particles (tungsten) according to the present invention and the resistivity of the PTC element at room temperature;

FIG. 3 is a characteristic diagram showing the relationship between the amount of the conductive particles (tungsten) according to the present invention and torque during the kneading;

FIG. 4 is a characteristic diagram showing the PTC curve representing the relationship between the temperature and the resistivity of the PTC element according to Example 1 of the present invention;

FIG. 5 is a characteristic diagram showing the relationship between the resistivity of the PTC element according to Example 1 and the peak current (I_{P}) at cut-off of an over-current.

FIGS. 6a and 6b are schematic illustrations of an optical microscope photographs taken before and after a current limiting test, respectively, showing the dispersion condition of tungsten particles, which are the conductive particles of the PTC composition according to Example 1 of the present invention; and

FIGS. 7a and 7b are schematic illustrations of an optical microscope photographs taken before and after a current limiting test, respectively, showing the dispersion of nickel particles, which are the conductive particles of the PTC element according to Comparative Example 1 of the present invention.

### DETAILED DESCRIPTION OF THE INVENTION

The polymeric PTC composition according to the present invention comprises an organic polymer and conductive particles having a melting point of not less than 2000° C. that are dispersed in the organic polymer.

With the polymeric PTC composition according to the present invention, the conductive particles having a melting point as high as not less than 2000° C. are not melted and do not form a local conductive circuit in the PTC composition, or in the element, when it is used under large current and high voltage. Even if an internal arc is generated, unlike the PTC composition containing the conventional metal particles, the PTC composition, or the PTC element of the present invention is not electrically destroyed. Also, when a large current flows, the temperature of the PTC element increases and the resistance increases as well, therefore a circuit can be protected against an over-current.

In addition, the resistivity of the PTC composition according to the present invention at room temperature (ρ_{L}) can be sufficiently decreased so that good conductivity is exhibited under normal operating conditions and the peak resistance (ρ_{H}) at an elevated temperature can be increased. Thus, ρ_{H}/ρ_{L} can be increased, so the flow of current can be securely cut-off when large current flows through the PTC composition. Thus a PTC composition having an excellent current limiting performance, high safety and high reliability can be obtained, and the circuit protection device employing a PTC element comprising this PTC composition functions well repeatedly as a self-reset type over-current protection element.

CB is a sublimating substance having no melting point and is not included in the category of the conductive particles according to the present invention.

The average particles size of the conductive particle is preferably 0.01-10 μm, more preferably it is 0.1-10 μm. The reason is as follows: when the organic polymer is loaded with the conductive particles, particles having a small average particle size—having a narrow particle size distribution, and being bulky—cannot be loaded in a large amount and the resistivity of the PTC element at room temperature is increased. On the other hand, the particles having a large average particle size result in increase of the resistivity of the PTC element at room temperature when the same amount of the particles are loaded in the polymer. FIG. 1 is a characteristic diagram showing the relationship between the size of tungsten particles contained in the PTC element, and the resistivity of the PTC element at room temperature. Black circles represent the case wherein the tungsten was loaded in an amount of 90% by weight, and white circles represent the case wherein the tungsten was loaded in an amount of 95% by weight. It is shown that the resistivity of the PTC element at room temperature increases with an increase in average particle size. By the use of the conductive particles having the above-mentioned average particle size, a PTC composition having a low resistivity at room temperature can be obtained. The conductive particles having various particle sizes can be appropriately selected according to the application and the desired characteristics of the PTC composition.

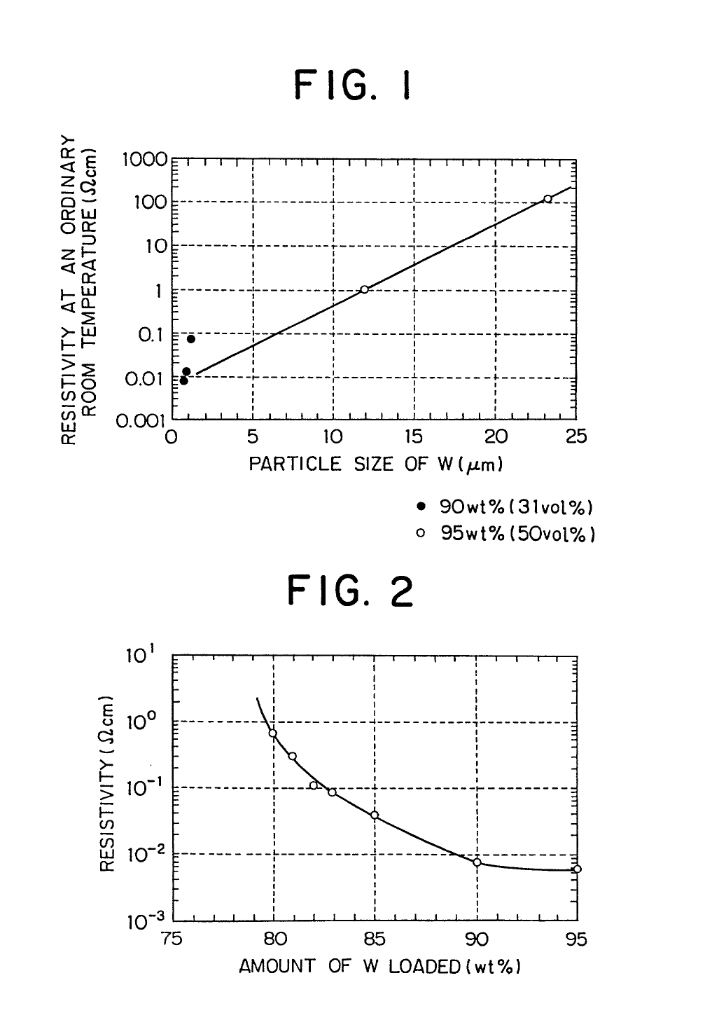

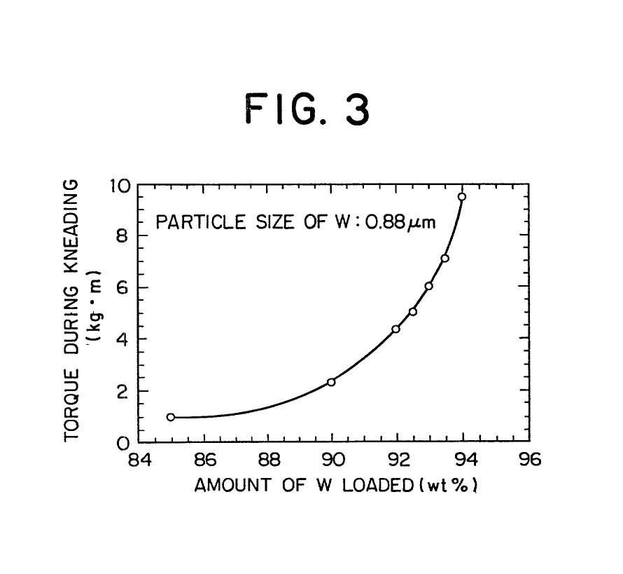

The content of the conductive particles is preferably 50-99% by weight, more preferably it is 70-97% by weight based on the PTC composition. With low content of the conductive particles,the resistivity at room temperature is increased. When the content of the conductive particles is increased, the kneading torque during the kneading of the organic polymer with the conductive particles becomes high, and the kneading becomes difficult to carry out and the resulting PTC element shows low elasticity and a weak impact resistance. FIG. 2 is a characteristic diagram showing the relationship between the amount of tungsten loading and the resistivity of the PTC element at room temperature, and it is shown that the resistivity of the PTC element at room temperature increases with a decrease in amount of tungsten loading. FIG. 3 is a characteristic diagram showing the relationship between the amount of tungsten loaded and torque during the kneading, and it is shown that the torque during the kneading increases with an increase in amount of tungsten loaded. The measurement was carried out by Laboplastomill equipment under kneading conditions of 200° C. and 50 rpm.

As the conductive particles, any particle can be used as far as it has a melting point of not less than 2000° C., has such electrical conductivity, heat conductivity and fusion resistance to micro arc that are good enough for a PTC composition, and provides excellent PTC characteristics. Particles of a metal, metal carbide, metal boride, metal silicide and metal nitride are used as the conductive particles. These can be used alone or in admixture of two or more kinds, and appropriately selected according to the application and the desired characteristics of the PTC composition.

An example of the metal particles includes tungsten (W). Examples of the metal carbide include TiC, ZrC, VC, NbC, TaC, MO₂C, and WC. Examples of the metal nitride include TiN, ZrN, VN, NbN, TaN, and Cr₂N. Examples of the metal silicide include TaSi₂, MoSi₂, and WSi₂. Examples of the metal boride include TiB₂, ZrB₂, NbB₂, TaB₂, CrB, MoB, and WB. (Ti: titanium, Zr: zirconium, V: vanadium, Nb: niobium, Ta: tantalum, Mo: molybdenum, and Cr: chromium.) Most preferred are W and WC.

In particular, it is preferable to use particles of tungsten, and the carbide, boride, silicide and nitride thereof. Tungsten is a metal having the highest melting point (3410° C.) among the metal particles, besides tungsten and a tungsten compound of a desired particle size are easily available as they are supplied steadily.

As the organic polymer, polyethylene, polyethylene oxide, polybutadiene, polyethylene acrylate, ethylene-ethyl acrylate copolymer, ethylene-acrylic acid copolymer, polyester, polyamide, polyether, polycaprolactam, fluorinated ethylene-propylene copolymer, chlorinated polyethylene, chlorosulphonated ethylene, ethylene-vinyl acetate copolymer, polypropylene, polystyrene, styrene-acrylonitrile copolymer, polyvinyl chloride, polycarbonate, polyacetal, polyalkylene oxide, polyphenylene oxide, polysulphone and a fluororesin are used according to the present invention and these can be used alone or two or more kinds of the compounds selected from these are used in admixture as a blended polymer. The kind, and the composition ratio of the organic polymer can be appropriately selected according to the desired property, and application.

Particularly preferred is a high density polyethylene having a crystallinity of at least 60% and a melting point of 120 to 140° C. Higher crystallinity provides lower resistivity of room temperature and more improved PTC properties regarding resistivity. Furthermore, lower melting point provides lower peak current at a, cut-off an over-current. In the present invention, the crystallinity means a value determined by a method in accordance with JIS K 7112.

The PTC composition is prepared by mixing the organic polymer, conductive particles and other additives at a desired ratio followed by kneading. The conductive particles can be added to the organic polymer, then kneaded, or both materials can be simultaneously mixed and kneaded. The blending ratio of the organic polymer and the conductive particles can be appropriately selected according to the content of the conductive particles in the desired composition, the kind of the organic polymer, and the kind of the kneaders such as a Banbury mixer, pressure kneader and roll mill, but the amount of the conductive particles loaded shall be within the range of from 50 to 99% by weight based on the PTC composition.

In the preparation of the above-mentioned PTC composition, use of conductive particles which have been preliminarily subjected to a coupling treatment will improve the environmental resistance properties such as high temperature, high humidity resistance or heat shock resistance.

As a coupling agent, a titanate coupling agent and an aluminum coupling agent can be used. Examples of the titanate coupling agent include monoalkoxy types such as isopropyltriisostearoyl titanate, isopropyltrioctanoyl titanate, isopropyldiisostearoylcumylphenyl titanate, isopropyldistearoylmethacryl titanate, isopropyltri (dioctylpyrophosphate) titanate, or tetraisopropyldi (dilaurylphosphite) titanate, isostearoyloxy acetate, isostearoylacryloxy acetate, distearoylethylene titanate, and dimethacrylethylene titanate. As an aluminum coupling agent, any agent which is effective for improving the adhesion between the metal and the plastic, such as acetoalkoxyaluminum diisopropylate can be used.

The amount of the above-mentioned coupling agent is 0.05 -10% by weight based on the conductive particles in order to improve the environmental resistance properties.

For preparation of the PTC composition, various additives can be mixed, if necessary, with the above-mentioned organic polymer, conductive particles and the coupling agent. Examples of the additive include an antioxidant, a stabilizer, and a flame-retardant such an antimony compound, phosphorus compound, chlorine compound and bromine compound.

The PTC composition of the present invention can be used for various uses. When it is used as a PTC element, the PTC composition can be molded into, illustratively, a film form and metal foil electrodes are bonded on the front and the back surfaces of the film by thermo-compression bonding to form a laminate, then the laminate is cut to a desired size and lead wires are attached to the electrode surface by soldering, brazing, or spot welding and the like to provide a PTC element.

In the meantime, as aforementioned, Japanese Patent Laid-Open No. 5-508055 relates to a method for producing a electronic device and discloses a composition comprising polymeric material and conductive particles dispersed therein. Almost Examples of the publication use nickel as the conductive particles of the PTC element. However, nothing in the publication discloses or suggests the use of conductive particles having a melting point of not less than 2000° C. This publication uses metallic materials such as a metal carbide, metal boride and metal nitride as a conductive material of a PTC composition. To the contrary, one of aims of the present invention lies in obtaining a circuit protection device to which a polymeric PTC composition comprising an organic polymer and conductive particles having a melting point of not less than 2000° C. dispersed therein is applied. If large current (for example, over current of 50 KA) flows through the circuit by short-circuit accident, arc (6000° C. or more) occurs at electrode portions of the PTC elements. The present inventors found by experiments using metallic materials having several melting points that when conductive particles having a melting point of 2000° C. or less, which are exemplified by copper (m.p.=1083° C.) and nickel (m.p.=1453° C.), are used as a material for the PTC element, the conductive particles are melted and bonded together by generated heat to allow large current flow to the bonded parts which leads to decomposition of the PTC elements so that the circuit protection is not achieved. The publication describes that “the manufactured device is excellently suited for use as PTC element” in Example 1. However, this is incorrect as the conventional PTC element cannot protect the circuit from over-current. Therefore, conductive particles of the PTC element which can protect from over current are metals having a high melting point such as 2000° C. or more and carbon black which is a sublimating substance and has no melting point. However, carbon black provides poor current limiting performance.

According to the first constitution of the polymeric PTC composition of the present invention, there is an advantage that the polymeric PTC composition shows a low resistance and good conductivity under normal operating conditions, and even under large current and high voltage, the conductive particles are not melted to locally form a conductive circuit, but the resistance is increased due to the PTC characteristics to protect the circuit against the over-current by dispersing the conductive particles having a melting point of not less than 2000° C. in an organic polymer. There is also an advantage that a polymeric PTC composition having excellent PTC characteristics, and current limiting performance, high safety and reliability can be obtained.

According to the second constitution of the polymeric PTC composition of the present invention, there is an advantage that a polymeric PTC composition having a low resistivity at an ordinary room temperature can be obtained by the use of conductive particles having an average particle size of 0.01-50 μm in the first constitution.

According to the third constitution of the polymeric PTC composition of the present invention, there is an advantage that a polymeric PTC composition having a low resistivity at an ordinary room temperature which is more suited for practical use can be obtained by incorporating the conductive particles in the composition in an amount of 50-99% by weight in the first or second constitution.

According to the fourth constitution of the polymeric PTC composition of the present invention, there is an advantage that a polymeric PTC composition having excellent PTC characteristics and current limiting performance can be obtained by employing particles containing at least one kind of a metal, metal carbide, metal boride, metal siliside and metal nitride as conductive particles in the first, second or third constitution.

According to the fifth constitution of the polymeric PTC composition of the present invention, there is an advantage that a polymeric PTC composition having higher safety and reliability, excellent PTC characteristics and current limiting performance can be obtained by employing tungsten as the metal in the fourth constitution.

According to the sixth, seventh or eighth constitution of the polymeric PTC composition of the present invention, there is an advantage that environmental resistance properties can be improved by treating the conductive particles with a coupling agent.

The circuit protection device according to the present invention, wherein conductive particles having a melting point of not less than 2000° C., which are treated with a coupling agent are dispersed in an organic polymer, is advantageous since it shows a low resistivity under normal operating conditions, has excellent circuit protecting function against over-current under large current and high voltage, has good environmental resistance properties and works with high repeat stability, therefore it is of high safety and high reliability.

### EXAMPLES

To further illustrate this invention, and not by way of limitation, the following examples are given.

### Example 1

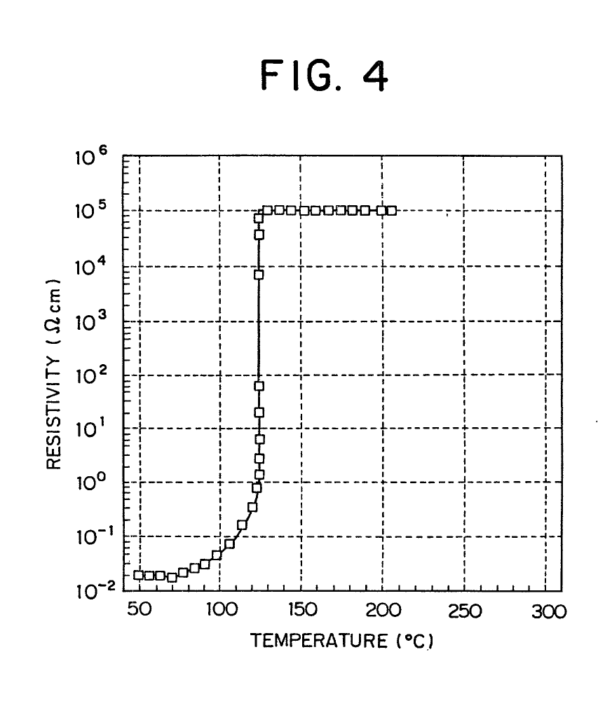

10 parts by weight of high density polyethylene (abbreviated as HDPE, available from Mitsubishi Chemical Co., Ltd., under the trade name of HJ560) as an organic polymer, having a crystallinyty of 75% and a melting point of 135° C., 90 parts by weight of tungsten (having an average particle size of 0.88 μm, available from Nippon Shinkinzoku Co., Ltd., under the trade name of W-1) as conductive particles, and 2 parts by weight of a phenol type antioxidant (available from Ciba-Geigy Co., Ltd., under the trade name of Irganox 1010) were kneaded by Laboplastomill equipment (manufactured by Toyo Seiki Co., Ltd.) at 200° C. for 15 minutes. The produced PTC composition was hot-pressed to provide a plate of 40×60×1 mm. A polyethylene frame was produced by injection molding on the periphery of this plate for 20 mm to carry out insulation at the cut-off. Then the laminate with the frame was sandwiched between electrodes to provide a PTC element. The characteristic diagram of FIG. 4 illustrates the PTC curve showing the relationship between the temperature and the resistivity of the PTC element. The resistivity at room temperature (ρ_{L}) was 0.01 Ωcm, peak resistivity (ρ_{H}) was 10⁵ Ωcm, ρ_{H}/ρ_{L} was 10⁷. When the resistance of the PTC element at room temperature was 1.2 mΩ, the cut-off current for the over-current of 50 kA at 300 V was 7.5 kA.

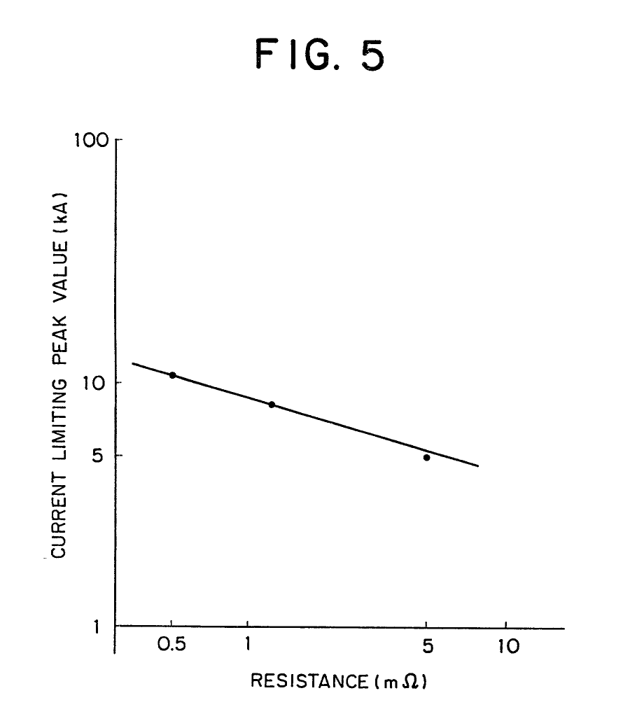

Using PTC elements having different sizes and different resistances, the relationship between the resistance of the PTC element comprising the PTC composition and the current limiting peak value (peak current at the cut-off of the over-current: I_{P}) was examined. The results are shown by the characteristic diagram of FIG. 5.

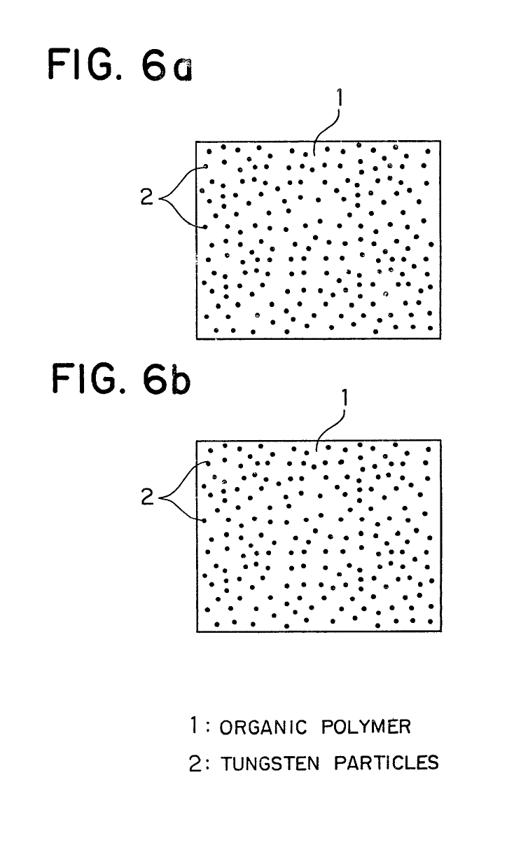

FIGS. 6a and 6b are schematic illustrations of an optical microscope photograph showing the dispersion condition of tungsten particles 2, which are the conductive particles of the PTC composition; FIG. 6a shows the condition before the cut-off (current limiting) test, and FIG. 6b shows the condition after the cut-off test. The FIGS. show that there was no change between the conditions before and after the cut-off test, and that tungsten particles 2 were similarly and homogeneously dispersed in the organic polymer 1.

### Example 2

10 parts by weight of HDPE (available from Mitsubishi Chemical Co., Ltd., under the trade name of HJ560), 90 parts by weight of a metal carbide, WC, (having an average particle size of 0.7 μm, a melting point of 2785° C., available from Nippon Shinkinzoku Co., Ltd. under the trade name of WC-10) as conductive particles, and 2 parts by weight of a phenol type antioxidant (available from Ciba-Geigy Ltd., under the trade name of Irganox 1010) were kneaded by Laboplastomill equipment (manufactured by Toyo Seiki Co., Ltd.) at 200° C. for 15 minutes. The produced PTC composition was hot-pressed to provide a plate of 40×60×1 mm. A polyethylene frame was produced by injection molding on the periphery of the plate for 20 mm to carry out insulation at the cut-off. Then the laminate with the frame was sandwiched between electrodes to provide a PTC element. When the resistance of the PTC element at a room temperature was 1.5 mΩ, the cut-off current for the over-current of 50 kA at 300 V was 8 kA.

### Example 3

10 parts by weight of HDPE (available from Mitsubishi Chemical Co., Ltd., under the trade name of JH560), 90 parts by weight of a metal nitride, ZrN (having an average particle size of 1 μm, a melting point of 2980° C., manufactured by Nippon Shinkinzoku Co., Ltd.) as conductive particles, and 2 parts by weight of a phenol type antioxidant (available from Ciba-Geigy Ltd., under the trade name of Irganox 1010) were kneaded by Laboplastomill equipment (manufactured by Toyo Seiki Co., Ltd.) at 200° C. for 15 minutes. The produced PTC composition was hot-pressed to provide a plate of 40×60×1 mm. A polyethylene frame was produced by injection molding on the periphery of the plate for 20 mm to carry out insulation at the cut-off. Then the laminate with the frame was sandwiched between electrodes to provide a PTC element. When the resistance of the PTC element at a room temperature was 1.1 mΩ, the cut-off current for the over-current of 50 kA at 300 V was 8.5 kA.

### Example 4

10 parts by weight of HDPE (available from Mitsubishi Chemical Co., Ltd., under the trade name of HJ560), 90 parts by weight of a metal siliside, WSi₂ (having an average particle size of 1 μm, a melting point of 2160° C., manufactured by Nippon Shinkinzoku Co., Ltd.) as conductive particles, and 2 parts by weight of a phenol type antioxidant (available from Ciba-Geigy Ltd., under the trade name of Irganox 1010) were kneaded by Laboplastomill equipment (manufactured by Toyo Seiki Co., Ltd.) at 200° C. for 15 minutes. The produced PTC composition was hot-pressed to provide a plate of 40×60×1 mm. A polyethylene frame was produced by injection molding on the periphery of the plate for 20 mm to carry out insulation at the cut-off. Then the laminate with the frame was sandwiched between electrodes to provide a PTC element. When the resistance of the PTC element at a room temperature was 1.3 mΩ, the cut-off current for the over-current of 50 kA at 300 V was 8 kA.

### Example 5

10 parts by weight of a mixture of HDPE (available from Mitsubishi Chemical Co., Ltd., under the trade name of HJ560) and polypropylene (available from Mitsubishi Chemical Co., Ltd., under the trade name of MA03) in equal proportions, 90 parts by weight of a metal boride, WB (having an average particle size of 1 μm, a melting point of 3700° C., manufactured by Nippon Shinkinzoku Co., Ltd.) as conductive particles, and 2 parts by weight of a phenol type antioxidant (available from Ciba-Geigy Ltd., under the trade name of Irganox 1010) were kneaded by Laboplastomill equipment (manufactured by Toyo Seiki Co., Ltd.) at 200° C. for 15 minutes. The produced PTC composition was hot-pressed to provide a plate of 40×60×1 mm. A polyethylene frame was produced by injection molding on the periphery of the plate for 20 mm to carry out insulation at the cut-off. Then the laminate with the frame was sandwiched between electrodes to provide a PTC element. When the resistance of the PTC element at a room temperature was 1.2 mΩ, the cut-off current for the over-current of 50 kA at 300 V was 8 kA.

When the organic polymer was changed from a mixture of high density polyethylene and polypropylene to high density polyethylene alone, polypropylene alone or a mixture of polyethylene and polypropylene to form a PTC element similarly in the above-mentioned composition, similar PTC characteristics were observed.

### Example 6

10 parts by weight of polypropylene (available from Mitsubishi Chemical Co., Ltd., under the trade name of MA03), 90 parts by weight of tungsten (having an average particle size of 0.88 μm, available from Nippon Shinkinzoku Co., Ltd. under the trade name of W-1) as conductive particles, and 2 parts by weight of a phenol type antioxidant (available from Ciba-Geigy Ltd., under the trade name of Irganox 1010) were kneaded by Laboplastomill equipment (manufactured by Toyo Seiki Co., Ltd.) at 200° C. for 15 minutes. The produced PTC composition was hot-pressed to provide a plate of 40×60×1 mm. A polyethylene frame was produced by injection molding on the periphery of the plate for 20 mm to carry out insulation at the cut-off. Then the laminate with the frame was sandwiched between electrodes to provide a PTC element. The PTC curve obtained was the same as that of Example 1 shown in FIG. 4. The resistivity at an ordinary room temperature (ρ_{L}) was 0.01 Ωcm, the peak resistivity (ρ_{H}) was 10⁵ Ωcm, ρ_{H}/ρ_{L} was 10⁷. When the resistance of the PTC element at a room temperature was 1.2 mΩ, the cut-off current for the over-current of 50 kA at 300 V was 7.5 kA.

### Example 7

100 parts by weight of tungsten (having an average particle size of 0.88 μm, available from Nippon Shinkinzoku Co., Ltd. under the trade name of W-1) were added to a solution comprising 1 part by weight of a titanate type coupling agent (available from Ajinomoto Co., Ltd., under the trade name of KR TTS) dissolved in 28 parts by weight of isopropyl alcohol, and mixed for 10 minutes. The isopropyl alcohol was removed by filtration and the composition left on the filter paper was dried under vacuum for 24 hours.

90 parts by weight of the dried composition (tungsten having subjected to coupling treatment), 10 parts by weight of HDPE (available from Mitsubishi Chemical Co., Ltd., under the trade name of HJ560), and 2 parts by weight of a phenol type antioxidant (available from Ciba-Geigy Ltd., under the trade name of Irganox 1010) were kneaded by Laboplastomill equipment (manufactured by Toyo Seiki Co., Ltd.) at 200° C. for 15 minutes. The produced PTC composition was hot-pressed to provide a plate of 40×60×1 mm. A polyethylene frame was produced by injection molding on the periphery of the plate for 20 mm to carry out insulation at the cut-off. Then the plate of the PTC composition with the frame was sandwiched between electrodes to provide a PTC element. The resistivity at an ordinary room temperature (ρ_{L}) was 0.01 Ωcm, the peak resistivity (ρ_{H}) was 10⁵ Ωcm, ρ_{H}/ρ_{L} was 10⁷. When the resistance of the PTC element at a room temperature was 1.2 mΩ, the current limiting peak value for the over-current of 50 kA at 300 V was 7.5 kA.

A PTC element having an initial resistivity of 0.02 Ωcm was subjected to an environmental test (under high temperature, high humidity of 85° C. and 85%) and it showed a resistivity of 0.1 Ωcm after 1000 hours. On the other hand, the resistivity of a PTC element which had not subjected to the coupling treatment given in Example 7 was very much increased from its initial value of 0.02 Ωcm to 960 Ωcm after 1000 hours.

A PTC element having an initial resistivity of 0.02 Ωcm was subjected to an environmental test (heat shock cycle test of −25° C. for 30 minutes and 85° C. for 30 minutes) then it showed a resistivity of 0.2 Ωcm after 300 cycles. On the other hand, the resistivity of a PTC element which had not been subjected to the coupling treatment given in Example 7 was very much increased from its initial value of 0.02 Ωcm to 100 Ωcm after 300 cycles.

### Example 8

100 parts by weight of tungsten carbide (having an average particle size of 0.7 μm, available from Nippon Shinkinzoku Co., Ltd. under the trade name of WC-10) were added to a solution comprising 1 part by weight of an aluminium type coupling agent (available from Ajinomoto Co., Ltd., under the trade name of AL-M) dissolved in 28 parts by weight of isopropyl alcohol, and mixed for 10 minutes. The isopropyl alcohol was removed by filtration and the composition left on the filter paper was dried under vacuum for 24 hours.

90 parts by weight of the dried composition (tungsten carbide having subjected to coupling treatment), 10 parts by weight of HDPE (available from Mitsubishi Chemical Co., Ltd., under the trade name of HJ560), and 2 parts by weight of a phenol type antioxidant (available from Ciba-Geigy Ltd., under the trade name of Irganox 1010) were kneaded by Laboplastomill equipment (manufactured by Toyo Seiki Co., Ltd.) at 200° C. for 15 minutes. The produced PTC composition was hot-pressed to provide a plate of 40×60×1 mm. A polyethylene frame was produced by injection molding on the periphery of the plate for 20 mm to carry out insulation at the cut-off. Then the plate of the PTC composition with the frame was sandwiched between electrodes to provide a PTC element. The resistivity at an ordinary room temperature (ρ_{L}) was 0.01 Ωcm, the peak resistivity (ρ_{H}) was 10⁵ Ωcm, ρ_{H}/ρ_{L} was 10⁷. When the resistance of the PTC element at a room temperature was 1.2 mΩ, the current limiting peak value for the over-current of 50 kA at 300 V was 8 kA.

A PTC element having an initial resistivity of 0.02 Ωcm was subjected to an environmental test (under high temperature, high humidity of 85° C. and 85%), and it showed a resistivity of 0.03 Ωcm after 1000 hours. On the other hand, the resistivity of a PTC element which had not been subjected to the coupling treatment given in Example 8 was very much increased from its initial value of 0.02 Ωcm to 115 Ωcm after 1000 hours.

A PTC element having an initial resistivity of 0.02 Ωcm was subjected to an environmental test (heat shock cycle test of −25° C. for 30 minutes and 85° C. for 30 minutes) and it showed a resistivity of 0.15 Ωcm after 300 cycles. On the other hand, the resistivity of a PTC element which had not been subjected to the coupling treatment given in Example 8 was very much increased from its initial value of 0.02 Ωcm to 1.6 Ωcm after 300 cycles.

### Examples 9-33

PTC elements were prepared in a process analogous to that shown in the above-mentioned Example 7 or Example 8 by changing the kinds of the polymers, fillers and coupling agents in the PTC compositions as shown in Table 1 and Table 2, and environmental resistance properties were determined. The results are shown together with those of Examples 7 and 8. Table 1 and Table 2 show that the coupling treatment provides good results for the environmental test and does not affect the current limiting peak value.

TABLE 1

| | | | | Current | | | Heat |
|---|---|---|---|---|---|---|---|
| | | Filler | | limiting | Initial | High Tempera- | shock: |
| | Polymer | (parts | Coupling agent | peak value | resist- | ture high | after 300 |
| Example | (parts by | by | (parts by | at 300 V, 50 | ivity | humidity: 85° C. | cycles |
| No. | weight) | weight) | weight) | KA (KA) | (Ωcm) | 85% (Ωcm) | (Ωcm) |
| 7 | HDPE(10) | W(90) | KRTTS(0.27) | 7.5 | 0.02 | 0.1 | 0.2 |
| 8 | HDPE(10) | WC(90) | AL-M(0.27) | 8 | 0.02 | 0.03 | 0.15 |
| 9 | HDPE(10) | W(90) | KR138S(0.27) | 7.5 | 0.03 | 0.1 | 0.2 |
| 10 | HDPE(10) | W(90) | KR9SA(0.27) | 7.5 | 0.02 | 0.1 | 0.2 |
| 11 | HDPE(10) | W(90) | KR55(0.27) | 8 | 0.02 | 0.3 | 0.5 |
| 12 | HDPE(10) | W(90) | KR41B(0.27) | 7.7 | 0.02 | 0.4 | 0.5 |
| 13 | HDPE(10) | W(90) | KR38S(0.27) | 7.8 | 0.02 | 0.3 | 0.5 |
| 14 | HDPE(10) | W(90) | KR46B(0.27) | 8 | 0.02 | 0.4 | 0.6 |
| 15 | HDPE(10) | W(90) | KR238S(0.27) | 7.7 | 0.02 | 0.4 | 0.4 |
| 16 | HDPE(10) | W(90) | 338X(0.27) | 7.9 | 0.02 | 0.3 | 0.5 |
| 17 | HDPE(10) | W(90) | KR44(0.27) | 8.1 | 0.02 | 0.3 | 0.5 |
| 18 | HDPE(10) | WC(90) | KRTTS(0.27) | 9 | 0.02 | 0.1 | 0.2 |
| 19 | HDPE(10) | WC(90) | KR138S(0.27) | 9 | 0.02 | 0.1 | 0.2 |
| 20 | HDPE(10) | WC(90) | KR9SA(0.27) | 9 | 0.02 | 0.1 | 0.2 |
| Ltd. | | | | | | | |

TABLE 2

| | | | | Current | | | Heat |
|---|---|---|---|---|---|---|---|
| | | Filler | | limiting | Initial | High Tempera- | shock: |
| | Polymer | (parts | Coupling agent | peak value | resist- | ture high | after 300 |
| Example | (parts by | by | (parts by | at 300 V, 50 | ivity | humidity: 85° C. | cycles |
| No. | weight) | weight) | weight) | KA (KA) | (Ωcm) | 85% (Ωcm) | (Ωcm) |
| 21 | HDPE(10) | WC(90) | KR55(0.27) | 9 | 0.02 | 0.4 | 0.5 |
| 22 | HDPE(10) | WC(90) | KR41B(0.27) | 9 | 0.02 | 0.4 | 0.5 |
| 23 | HDPE(10) | WC(90) | KR38S(0.27) | 9 | 0.02 | 0.4 | 0.5 |
| 24 | HDPE(10) | WC(90) | KR46B(0.27) | 9 | 0.02 | 0.4 | 0.5 |
| 25 | HDPE(10) | WC(90) | KR238S(0.27) | 9 | 0.02 | 0.4 | 0.5 |
| 26 | HDPE(10) | WC(90) | 338X(0.27) | 9 | 0.02 | 0.3 | 0.5 |
| 27 | HDPE(10) | WC(90) | KR44(0.27) | 9 | 0.02 | 0.3 | 0.5 |
| 28 | PP(10) | W(90) | KRTTS(0.27) | 10 | 0.02 | 0.1 | 0.2 |
| 29 | PP(10) | WC(90) | AL-M(0.27) | 10 | 0.02 | 0.03 | 0.15 |
| 30 | PS(10) | WSi₂(90) | KRTTS(0.27) | 12 | 0.02 | 0.03 | 0.15 |
| 31 | PS(10) | WB(90) | AL-M(0.27) | 12 | 0.02 | 0.03 | 0.15 |
| 32 | PA(10) | TiC(90) | KRTTS(0.27) | 15 | 0.02 | 0.03 | 0.15 |
| 33 | PA(10) | TiN(90) | AL-M(0.27) | 15 | 0.02 | 0.03 | 0.15 |

*HDPE: High density polyethylene (HJ560 from Mitsubishi Chemical Co., Ltd.), PP: Polypropylene (WAO3 from Mitsubishi Chemical Co., Ltd.), PS: Polystyrene (S-PS from Idemitsu Chemical Co., Ltd.), and PA: Polyamide (1012c2 from Mitsubishi Empura).
* All of the coupling agents are manufactured by Ajinomoto Co., Ltd.

In the above-mentioned Examples, only one kind of metal or metal composite was used as the conductive particles, however, two or more kinds can be appropriately combined and used.

### Comparative Example 1

90 parts by weight of silver particles (having a melting point of 960.5° C., available from Novamet Co.) as conductive particles, 10 parts by weight of HDPE and 2 parts by weight of a phenol type antioxidant (available from Ciba-Geigy Ltd., under the trade name of Irganox 1010) were kneaded by Laboplastomill equipment (manufactured by Toyo Seiki Co., Ltd.) at 200° C. for 15 minutes. The produced PTC composition was hot-pressed to provide a plate of 40×60×1 mm. A polyethylene frame was produced by injection molding on the periphery of the plate for 20 mm to carry out insulation at the cut-off. Then the laminate with the frame was sandwiched between electrodes to provide a PTC element. The PTC element having a resistance at a room temperature of 1 mΩ, could not cut off the flow of current even when large current of 50 kA flowed at high voltage of 300 V. We understand that this was because the PTC composition of the Comparative Example was loaded with silver particles having a low melting point, caused internal arc phenomenon (micro arc was generated among the conductive particles) under large current and high voltage, and the PTC composition was electrically destroyed. It is deemed that once the internal arc phenomenon was caused, the heat thereof melted the silver particles in the PTC composition, then the silver particles were bonded together and large current flowed through the bonded part and the composition underwent the electrical breakdown.

### Comparative Example 2

85 parts by weight of copper particles (having a melting point of 1083° C., an average particle size of 1.0 μm, available from Fukuda Kinzokuhaku Kogyo Co., Ltd.) as conductive particles, 15 parts by weight of HDPE and 2 parts by weight of a phenol type antioxidant (available from Ciba-Geigy Ltd., under the trade name of Irganox 1010) were kneaded by Laboplastomill equipment (manufactured by Toyo Seiki Co., Ltd.) at 200° C. for 15 minutes. A polyethylene frame was produced by injection molding on the periphery of the plate for 20 mm to carry out insulation at the cut-off. Then the laminate with the frame was sandwiched between electrodes. The PTC element having a resistance at a room temperature of 3 mΩ could not cut off the flow of current even when large current of 50 kA flowed at high voltage of 300 V. It is deemed that this was caused because copper particles having a low melting point were melted in the PTC composition to locally form a conductive circuit as is the case with Comparative Example 1.

### Comparative Example 3

85 parts by weight of nickel particles (having a melting point of 1452° C., available from Novamet Co.) as conductive particles, 15 parts by weight of HDPE and 2 parts by weight of a phenol type antioxidant (available from Ciba-Geigy Ltd., under the trade name of Irganox 1010) were kneaded by Laboplastomill equipment (manufactured by Toyo Seiki Co., Ltd.) at 200° C. for 15 minutes. A polyethylene frame was produced by injection molding on the periphery of the plate for 20 mm to carry out insulation at the cut-off. Then the laminate with the frame was sandwiched between electrodes. The PTC element having a resistance at a room temperature of 1 mΩ, could not cut off the flow of current even when large current of 50 kA flowed at high voltage of 300 V. It is deemed that this was because nickel particles in the PTC composition were melted to locally form a conductive circuit as is the case with Comparative Examples 1 and 2.

### Comparative Example 4

Example 1 was repeated except that an HDPE having a crystallinity of less than 60%. The resistivity at room temperature (ρ_{L}) was 1 Ωcm.

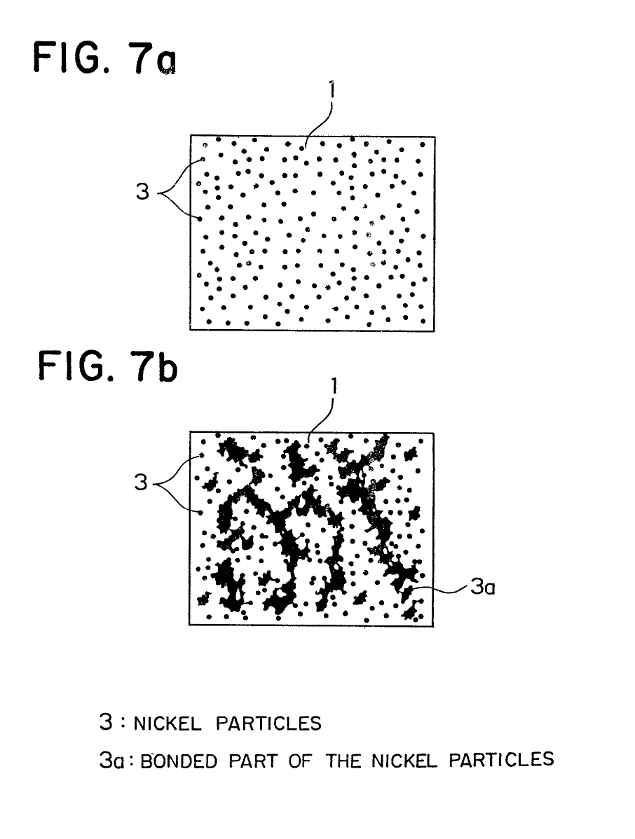

FIGS. 7a and 7b are schematic illustrations of optical microscope photograph showing the dispersion condition of nickel particles 3 in the PTC composition, and FIG. 7a illustrates the condition prior to the cut-off (current limiting) test, and FIG. 7b illustrates the condition after the cut-off test in which the device was destroyed. Prior to the cut-off test, the nickel particles 3 were homogeneously dispersed in the organic polymer 1, but after the cut-off test, the nickel particles 3 were melted and bonded together to form the bonded part of nickel particles 3a. It is deemed that since the nickel particles 3 in the PTC composition were melted to form the bonded part of nickel particles 3a (i.e. a conductive circuit was formed), the over-current could not be cut off as is the case with Comparative Examples 1 and 2, and the element was destroyed.

What is claimed is:

1. A polymeric positive temperature coefficient (PTC) composition comprising an organic polymer and conductive particles having a melting point of not less than 2000° C. dispersed in the organic polymer and selected from the group consisting of W and WC,
wherein an average particle size of said conductive particles is 0.01-10 μm,
wherein said conductive particles are contained in an amount of 50-99% by weight based on said composition,
wherein said conductive particles are treated with a coupling agent,
wherein said organic polymer is high density polyethylene having a melting point of from 120° C. to less than 140° C. and having a crystallinity of 60% or more, and
wherein said organic polymer is polyethylene having a melting point of from 120° C. to less than 140° C.,
wherein said composition is used under the condition that a ratio of over-current to an area of a PTC element consisting of said composition is at least 50 kA to 24 cm².

2. The polymeric PTC composition according to claim 1, wherein the metal is tungsten.

3. The polymeric PTC composition according to claim 1, wherein the coupling agent is an aluminum or a titanate coupling agent.

4. The polymeric PTC composition according to claim 1, wherein the coupling agent is present in an amount of 0.05-10% by weight of the conductive particles.

5. A circuit protection device comprising a positive temperature coefficient (PTC) element and at least two electrodes which are electrically connected to the PTC element,
wherein said positive temperature coefficient (PTC) element consists of a positive temperature coefficient (PTC) composition comprising an organic polymer and conductive particles having a melting point of not less than 2000° C. dispersed in the organic polymer and selected from the group consisting of W and WC,
wherein an average particle size of said conductive particles is 0.01-10 μm,
wherein said conductive particles are contained in an amount of 50-99% by weight based on said composition,
wherein said conductive particles are treated with a coupling agent,
wherein said organic polymer is high density polyethylene having a melting point of from 120° C. to less than 140° C. and having a crystallinity of 60% or more, and
wherein said organic polymer is polyethylene having a melting point of from 120° C. to less than 140° C.,
wherein said composition is used under the condition that a ratio of over-current to an area of a PTC element consisting of said composition is at least 50 kA to 24 cm².
